(19) United States
(12) Patent Application Publication
(10) Pub. No.: US 2003/0078186 A1
(43) Pub. Date: Apr. 24, 2003

(54) Method and composition for the prevention of the auto-oxidation of flavors and fragrances

(76) Inventors: W. Denver Christopher, Perry Hall, MD (US); Richard Pisano JR., Cold Spring Harbor, NY (US)

Correspondence Address: Dennis P. Clarke, Miles & Stockbridge, Suite 500, 1751 Pinnacle Drive, McLean, VA, 22102, US

(21) Appl. No.: 09/978,779

(22) Filed: Oct. 18, 2001

(51) Int. Cl. C09K 15/00

(52) U.S. Cl. 512/1; 252/397

(57) ABSTRACT

A fragrance or flavor composition comprising a fragrance compound, a flavor compound or mixture thereof and an amount of a natural antioxidant that is inert with respect to the fragrance compound, flavor compound or mixture thereof in an amount sufficient to substantially stabilize the fragrance or flavor composition against auto-oxidation.

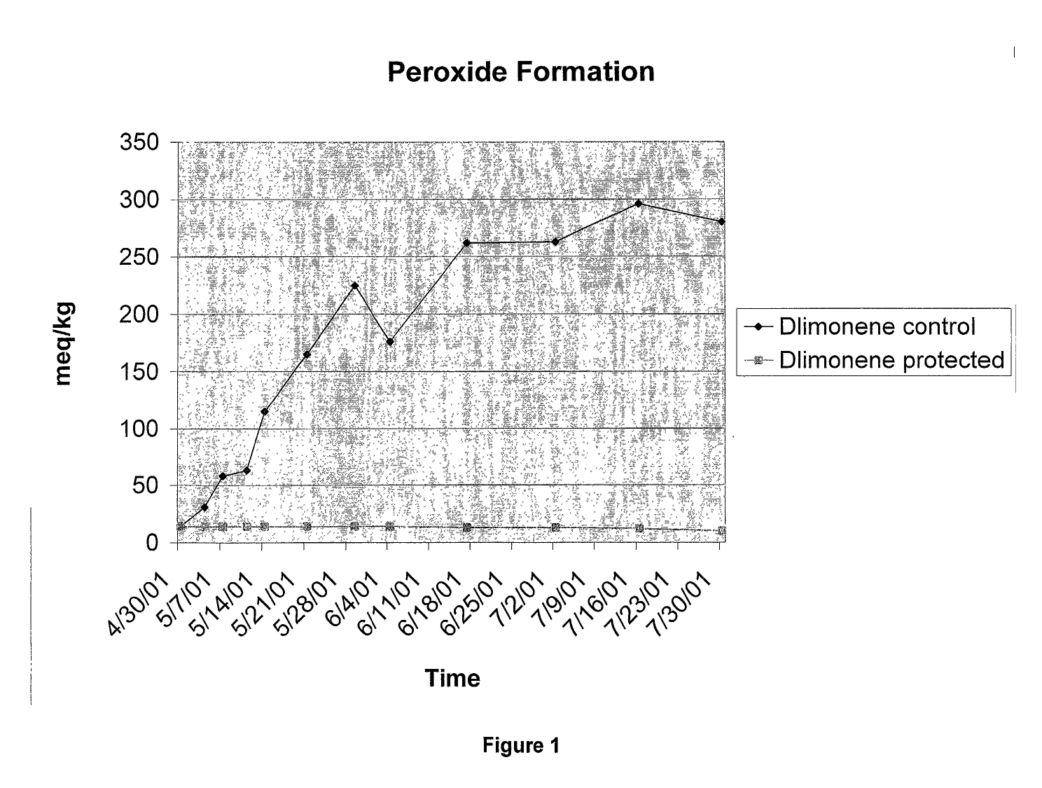

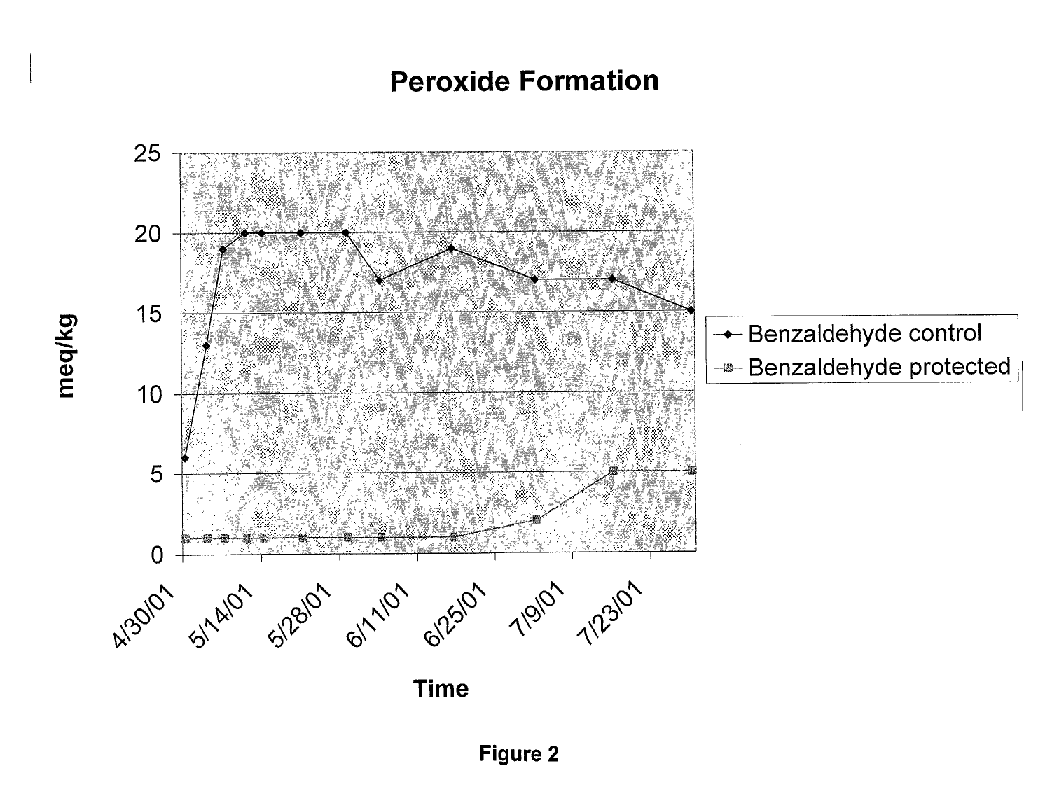

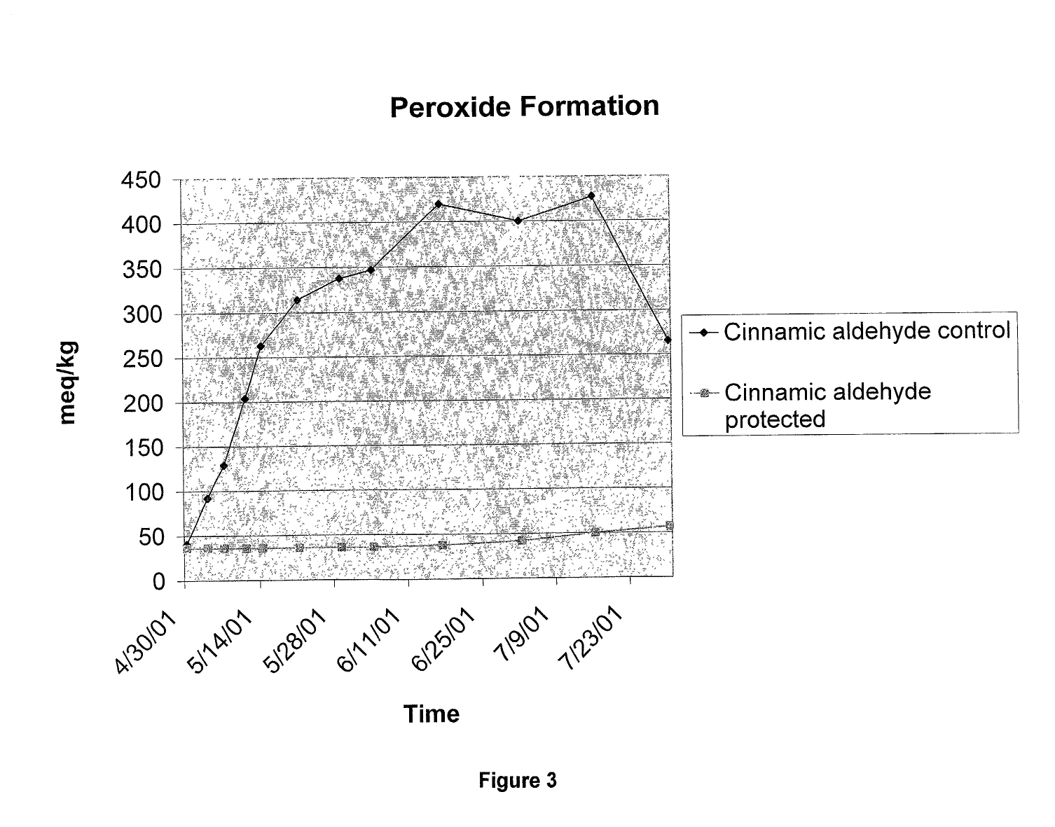

### BACKGROUND OF THE INVENTION

1. Field of the Invention

The invention relates to a method for preventing or diminishing the production of auto-oxidative products, primarily peroxides, in fragrance and flavor (F&F) products.

2. Description of the Prior Art

Peroxides that are formed in F&F products when the latter auto-oxidize can cause problematic reactions in humans, either of an allergenic or sensitization nature, when the products are utilized in foods, cosmetics and the like. These reactions can be highly disruptive to the life of the sufferer and can have long and short term effects on the health of individuals exposed thereto.

Antioxidants are known in the industry and function as inhibitory substances that prevent or inhibit oxidative changes in materials in which they are incorporated due to the presence of oxygen or other oxidative pressures therein. The antioxidants act as scavengers of any free radicals that form during auto-oxidation, thereby short-circuiting the oxidation process.

Heretofore, if materials were to be stabilized against auto-oxidation without the addition of significant odor or taste to the materials to be protected, synthetic antioxidants were required. However, the use of synthetic anti-oxidants has met with disfavor in recent years because of the perceived deleterious effects thereof on the environment. Indeed, some countries have banned the use of synthetic anti-oxidants, particularly in the F&F industry.

It is an object of the present invention to provide a natural auto-oxidative inhibitor that would be acceptable for use around the world as an antioxidant system and which does not impart a significant odor or flavor profile to the material in which it is incorporated for stabilization purposes.

### SUMMARY OF THE INVENTION

The above and other objects are realized by the present invention, one embodiment of which relates to a fragrance or flavor composition comprising a fragrance effective amount of a fragrance compound, a flavor effective amount of a flavor compound or mixture thereof and an amount of a natural antioxidant that is substantially inert with respect to the fragrance compound, flavor compound or mixture thereof in an amount sufficient to substantially stabilize the fragrance or flavor composition against auto-oxidation.

Another embodiment of the invention comprises a method for stabilizing a fragrance or flavor composition against auto-oxidation, the fragrance or flavor composition comprising a fragrance effective amount of a fragrance compound, a flavor effective amount of a flavor compound or mixture thereof, the method comprising the step of incorporating a stabilizing amount of a natural antioxidant in the composition.

A still further embodiment of the invention concerns a method of using a fragrance or flavor composition, the fragrance or flavor composition comprising a fragrance effective amount of a fragrance compound, a flavor effective amount of a flavor compound or mixture thereof and an amount of a natural antioxidant that is substantially inert with respect to the fragrance compound, flavor compound or mixture thereof in an amount sufficient to substantially stabilize the fragrance or flavor composition against auto-oxidation, comprising forming a composition containing an effective amount of the composition with a suitable carrier.

Another embodiment of the invention relates to an article of manufacture comprising a carrier having a fragrance or flavor composition incorporated therein wherein the fragrance or flavor composition comprises a fragrance effective amount of a fragrance compound, a flavor effective amount of a flavor compound or mixture thereof and an amount of a natural antioxidant that is substantially inert with respect to the fragrance compound, flavor compound or mixture thereof in an amount sufficient to substantially stabilize the fragrance or flavor composition against auto-oxidation.

A final embodiment of the invention concerns articles of manufacture comprising cosmetic products, foods (including prepared foods, meats and the like), seasoning and flavoring blends that include effective amounts of one of the above-described compositions.

### DETAILED DESCRIPTION OF THE INVENTION

Advantages associated with the present invention include:

1) Enables the storage of materials without or less refrigeration than heretofore.

2) Non-obvious over synthetic anti-oxidants in that latter are prone to be reactive with the products to be stabilized.

The invention is predicated on the discovery that the utilization as antioxidants the materials found in the Labiatae family of plants, primarily rosemary, effectively inhibit the formation of peroxides when incorporated in F&F materials. Moreover, the antioxidants function effectively without significantly altering the flavor and/or fragrance properties of the F&F materials. In a typical operation, the antioxidant materials are extracted from the plant and placed in a form which is conducive to introduction into F&F products. This invention makes use, but not limited to, the following compounds found in, e.g., rosemary: carnosic acid, carnasol, rosmanol, rosmadial, and rosmarinic acid. With the addition of this extracted material via a carrier material to the finished F&F the onset of oxidation is eliminated or delayed significantly. In accordance with this invention, a typical F&F product will have added to it an amount of the rosemary (or other Labiatae extract) in the parts per billion (ppb) or parts per million (ppm) range. The amount added will vary depending upon the sensitivity of the F&F material to oxidation. The extract is preferably incorporated in the F&F product via a carrier material. The carrier material preferably comprises the same material as that to be stabilized. For Example, to protect orange oil the carrier employed would be orange oil. The antioxidant material and orange oil would be combined to form masterbatches of known concentrations. Portions of the masterbatches would then be combined with the F&F material to form the finished product having the desired proportions of ingredients. It will be understood by those skilled in the art that any suitable method for combining the antioxidant with the F&F material may be employed. For purposes of illustrating the invention herein, the direct dilution method will be described. It has been discovered that by adding a carrier material that contains the rosemary extract in predetermined concentrations to a F&F product the latter will be protected against peroxide formation. [Methods for the detection of peroxides include titrametric utilizing the Peroxide value method found on page 198 of the Food Chemical Codex, 4th Edition.]

It is most preferred that the antioxidant material contain more than one of the antioxidant materials found in the plant material inasmuch as the antioxidative materials are found to have a positive synergistic effect on each other if they are present in combination.

### Examples

| Material | desired flMm) | carrier |
|---|---|---|
| Citrus Oils | 50 to 2000 | citrus oil |
| Oleoresin Paprika | 500 to 10000 | oleoresin paprika |
| Aroma chemicals | 10 to 100 | aroma chemical |
| Seasoning blends | 500 to 2000 | starch or oleo, or liquid. |

1. 180 kg of Orange oil had 1.8 kg of orange oil spiked with 5000 ppm of the rosemary extract to give a final value on 50 ppm.

2. 5000 pounds of a seasoning blend had 50 pounds of starch added spiked with 200000 ppm of rosemary extract added.

1. A fragrance or flavor composition comprising a fragrance effective amount of a fragrance compound, a flavor effective amount of a flavor compound or mixture thereof and an amount of a natural antioxidant that is substantially inert with respect to said fragrance compound, flavor compound or mixture thereof in an amount sufficient to substantially stabilize said fragrance or flavor composition against auto-oxidation.

2. The composition of claim 1 wherein said natural anti-oxidant is present in an amount sufficient to stabilize said composition against auto-oxidation which results in the formation of peroxides.

3. The composition of claim 1 wherein said natural antioxidant is an extract of a member of the family Labiatae or an active antioxidant ingredient thereof.

4. The composition of claim 3 wherein said Labiatae family member is rosemary.

5. The composition of claim 4 wherein said antioxidant ingredient of said rosemary extract is carnosic acid, carnasol, rosmanol, rosmadial, rosmarinic acid or mixtures thereof.

6. The composition of claim 1 wherein said fragrance compound, flavor compound or mixture thereof is citral, p-cymene, borneol, cinnamic alcohol, cinnamic aldehyde, dimethyl benzyl carbinol, 1-menthol, fenchyl alcohol, phenyl ethyl alcohol, o-tert-butyl cyclohexanol, 2-sec-butyl cyclohexanol, lauryl alcohol, 2-methyl undecanol, hexyl alcohol, citronellol, dihydro myrcenol, iso-amyl alcohol, tetrahydro linalool, dipropylene glycol, hexylene glycol, p-tert-butyl cyclohexanol, phenyl hexanol, 3,3,5-trimethyl hexanol, cis-trimethyl cyclohexanol, trans-2-hexanol, bornyl methoxy cyclohexanol, ethylene tridecane dioate, amyl salicylate, dimethyl benzyl carbinyl acetate, fenchyl acetate, n-hexyl salicylate, iso-bornyl acetate, o-tert-butyl cyclohexyl acetate, p-tert-butyl cyclohexyl acetate, phenyl ethyl acetate, tricyclodecenyl acetate, styrallyl acetate, methyl salicylate, allylamyl glycolate, allyl capronate, ethyl capronate, ethyl cinnamate, geranyl acetate, n-hexyl acetate, iso-amyl acetate, iso-nonyl acetate, triethyl citrate, rosephenene, dihydro mycenyl acetate, butyl-2-methyl varerate, trans-2-hexenyl acetate, dl-camphor, coumarin, pentyl cyclopentanone, iso-menthone, p-hydroxy phenyl butanone, 6-acetyl-1,1,3,4,4,6-hexamethyl tetrahydronaphthalene, ionone, p-tert-butyl cyclohexanone, o-tert-butyl cyclohexanone, 1-(2,6,6-trimethyl-1,3-cyclohexadiene-1-yl)-2-butene-1-one(Damascenone), 1-(2,6,6-trimethyl-2-cyclohexene 1-yl)-2-butene-1-one(Damascone .alpha.), 1-(2,6,6-trimethyl-1-cyclohexene-1-yl)-2-butene-1-one(Damascone .beta.), 1-(2,6,6-trimethyl-3-cyclohexene-1-yl)-2-butene-1-one (Delta Damascone), Dihydro Floriffone TD), p-mentha-8-thiol-3-one, gamma.-undecalactone, phenyl acetaldehyde dimethylacetal, octyl aldehyde, citronellal, methyl nonyl acetaldehyde, diphenyl oxide, phenyl ethyl isoamyl ether, 1,3,4,6,7,8-hexahydro-4,6,6,7,8,8-hexamethyl-cyclopenta-.gamma.-2-benzopyra n (Galaxolide), eucalyptus oil, lavender oil, lime oil, lemon oil, orange oil, grapefruit oil, pineneedle oil, peppermint oil, rosemary oil, spearmint oil, d'limonene, benzaldehyde or mixtures thereof.

7. A method for stabilizing a fragrance or flavor composition against auto-oxidation, said fragrance or flavor composition comprising a fragrance effective amount of a fragrance compound, a flavor effective amount of a flavor compound or mixture thereof, said method comprising the step of incorporating a stabilizing amount of a natural antioxidant in said composition.

8. The method of claim 7 wherein said natural anti-oxidant is present in an amount sufficient to stabilize said composition against auto-oxidation which results in the formation of peroxides.

9. The method of claim 7 wherein said natural antioxidant is an extract of a member of the family Labiatae or an active antioxidant ingredient thereof.

10. The method of claim 9 wherein said Labiatae family member is rosemary.

11. The method of claim 10 wherein said antioxidant ingredient of said rosemary extract is carnosic acid, carnasol, rosmanol, rosmadial, rosmarinic acid or mixtures thereof.

12. The method of claim 7 wherein said fragrance compound or mixture thereof is citral, p-cymene, borneol, cinnamic alcohol, cinnamic aldehyde, dimethyl benzyl carbinol, 1-menthol, fenchyl alcohol, phenyl ethyl alcohol, o-tert-butyl cyclohexanol, 2-sec-butyl cyclohexanol, lauryl alcohol, 2-methyl undecanol, hexyl alcohol, citronellol, dihydro myrcenol, iso-amyl alcohol, tetrahydro linalool, dipropylene glycol, hexylene glycol, p-tert-butyl cyclohexanol, phenyl hexanol, 3,3,5-trimethyl hexanol, cis-trimethyl cyclohexanol, trans-2-hexanol, bornyl methoxy cyclohexanol, ethylene tridecane dioate, amyl salicylate, dimethyl benzyl carbinyl acetate, fenchyl acetate, n-hexyl salicylate, iso-bornyl acetate, o-tert-butyl cyclohexyl acetate, p-tert-butyl cyclohexyl acetate, phenyl ethyl acetate, tricyclodecenyl acetate, styrallyl acetate, methyl salicylate, allylamyl glycolate, allyl capronate, ethyl capronate, ethyl cinnamate, geranyl acetate, n-hexyl acetate, iso-amyl acetate, iso-nonyl acetate, triethyl citrate, rosephenene, dihydro mycenyl acetate, butyl-2-methyl varerate, trans-2-hexenyl acetate, dl-camphor, coumarin, pentyl cyclopentanone, iso-menthone, p-hydroxy phenyl butanone, 6-acetyl-1,1,3,4,4,6-hexamethyl tetrahydronaphthalene, ionone, p-tert-butyl cyclohexanone, o-tert-butyl cyclohexanone, 1-(2,6,6-trimethyl-1,3-cyclohexadiene-1-yl)-2-butene-1-one(Damascenone), 1-(2,6,6-trimethyl-2-cyclohexene 1-yl)-2-butene-1-one(Damascone .alpha.), 1-(2,6,6-trimethyl-1-cyclohexene-1-yl)-2-butene-1-one(Damascone .beta.), 1-(2,6,6-trimethyl-3-cyclohexene-1-yl)-2-butene-1-one (Delta Damascone), Dihydro Floriffone TD), p-mentha-8-thiol-3-one, gamma.-undecalactone, phenyl acetaldehyde dimethylacetal, octyl aldehyde, citronellal, methyl nonyl acetaldehyde, diphenyl oxide, phenyl ethyl isoamyl ether, 1,3,4,6,7,8-hexahydro-4,6,6,7,8,8-hexamethyl-cyclopenta-.gamma.-2-benzopyra n (Galaxolide), eucalyptus oil, lavender oil, lime oil, lemon oil, orange oil, grapefruit oil, pineneedle oil, peppermint oil, rosemary oil, spearmint oil, d'limonene, benzaldehyde or mixtures thereof.

13. A method of using a fragrance or flavor composition, said fragrance or flavor composition comprising a fragrance effective amount of a fragrance compound, a flavor effective amount of a flavor compound or mixture thereof and an amount of a natural antioxidant that is substantially inert with respect to said fragrance compound, flavor compound or mixture thereof in an amount sufficient to substantially stabilize said fragrance or flavor composition against auto-oxidation, comprising forming a composition containing an effective amount of said composition with a suitable carrier.

14. The method of claim 13 wherein said natural anti-oxidant is present in an amount sufficient to stabilize said composition against auto-oxidation which results in the formation of peroxides.

15. The method of claim 13 wherein said natural antioxidant is an extract of a member of the family Labiatae or an active antioxidant ingredient thereof.

16. The method of claim 15 wherein said Labiatae family member is rosemary.

17. The method of claim 16 wherein said antioxidant ingredient of said rosemary extract is carnosic acid, carnasol, rosmanol, rosmadial, rosmarinic acid or mixtures thereof.

18. The method of claim 13 wherein said fragrance compound or mixture thereof is citral, p-cymene, borneol, cinnamic alcohol, cinnamic aldehyde, dimethyl benzyl carbinol, 1-menthol, fenchyl alcohol, phenyl ethyl alcohol, o-tert-butyl cyclohexanol, 2-sec-butyl cyclohexanol, lauryl alcohol, 2-methyl undecanol, hexyl alcohol, citronellol, dihydro myrcenol, iso-amyl alcohol, tetrahydro linalool, dipropylene glycol, hexylene glycol, p-tert-butyl cyclohexanol, phenyl hexanol, 3,3,5-trimethyl hexanol, cis-trimethyl cyclohexanol, trans-2-hexanol, bornyl methoxy cyclohexanol, ethylene tridecane dioate, amyl salicylate, dimethyl benzyl carbinyl acetate, fenchyl acetate, n-hexyl salicylate, iso-bornyl acetate, o-tert-butyl cyclohexyl acetate, p-tert-butyl cyclohexyl acetate, phenyl ethyl acetate, tricyclodecenyl acetate, styrallyl acetate, methyl salicylate, allylamyl glycolate, allyl capronate, ethyl capronate, ethyl cinnamate, geranyl acetate, n-hexyl acetate, iso-amyl acetate, iso-nonyl acetate, triethyl citrate, rosephenene, dihydro mycenyl acetate, butyl-2-methyl varerate, trans-2-hexenyl acetate, dl-camphor, coumarin, pentyl cyclopentanone, iso-menthone, p-hydroxy phenyl butanone, 6-acetyl-1,1,3,4,4,6-hexamethyl tetrahydronaphthalene, ionone, p-tert-butyl cyclohexanone, o-tert-butyl cyclohexanone, 1-(2,6,6-trimethyl-1,3-cyclohexadiene-1-yl)-2-butene-1-one(Damascenone), 1-(2,6,6-trimethyl-2-cyclohexene 1-yl)-2-butene-1-one(Damascone .alpha.), 1-(2,6,6-trimethyl-1-cyclohexene-1-yl)-2-butene-1-one(Damascone. beta.), 1-(2,6,6-trimethyl-3-cyclohexene-1-yl)-2-butene-1-one (Delta Damascone), Dihydro Floriffone TD), p-mentha-8-thiol-3-one, gamma.-undecalactone, phenyl acetaldehyde dimethylacetal, octyl aldehyde, citronellal, methyl nonyl acetaldehyde, diphenyl oxide, phenyl ethyl isoamyl ether, 1,3,4,6,7,8-hexahydro-4,6,6,7,8,8-hexamethyl-cyclopenta-.gamma.-2-benzopyra n (Galaxolide), eucalyptus oil, lavender oil, lime oil, lemon oil, orange oil, grapefruit oil, pineneedle oil, peppermint oil, rosemary oil, spearmint oil, d'limonene, benzaldehyde or mixtures thereof.

19. The method of claim 9 wherein said carrier is a food, cosmetic product, prepared food, meat, seasoning or flavoring blend.

20. An article of manufacture comprising a carrier having a fragrance or flavor composition incorporated therein wherein said fragrance or flavor composition comprises a fragrance effective amount of a fragrance compound, a flavor effective amount of a flavor compound or mixture thereof and an amount of a natural antioxidant that is substantially inert with respect to said fragrance compound, flavor compound or mixture thereof in an amount sufficient to substantially stabilize said fragrance or flavor composition against auto-oxidation.

21. The article of manufacture of claim 20 wherein said natural anti-oxidant is present in an amount sufficient to stabilize said composition against auto-oxidation which results in the formation of peroxides.

22. The article of manufacture of claim 20 wherein said natural antioxidant is an extract of a member of the family Labiatae or an active antioxidant ingredient thereof.

23. The article of manufacture of claim 22 wherein said Labiatae family member is rosemary.

24. The article of manufacture of claim 23 wherein said antioxidant ingredient of said rosemary extract is carnosic acid, carnasol, rosmanol, rosmadial, rosmarinic acid or mixtures thereof.

25. The article of manufacture of claim 20 wherein said fragrance compound or mixture thereof is citral, p-cymene, borneol, cinnamic alcohol, cinnamic aldehyde, dimethyl benzyl carbinol, 1-menthol, fenchyl alcohol, phenyl ethyl alcohol, o-tert-butyl cyclohexanol, 2-sec-butyl cyclohexanol, lauryl alcohol, 2-methyl undecanol, hexyl alcohol, citronellol, dihydro myrcenol, iso-amyl alcohol, tetrahydro linalool, dipropylene glycol, hexylene glycol, p-tert-butyl cyclohexanol, phenyl hexanol, 3,3,5-trimethyl hexanol, cis-trimethyl cyclohexanol, trans-2-hexanol, bornyl methoxy cyclohexanol, ethylene tridecane dioate, amyl salicylate, dimethyl benzyl carbinyl acetate, fenchyl acetate, n-hexyl salicylate, iso-bornyl acetate, o-tert-butyl cyclohexyl acetate, p-tert-butyl cyclohexyl acetate, phenyl ethyl acetate, tricyclodecenyl acetate, styrallyl acetate, methyl salicylate, allylamyl glycolate, allyl capronate, ethyl capronate, ethyl cinnamate, geranyl acetate, n-hexyl acetate, iso-amyl acetate, iso-nonyl acetate, triethyl citrate, rosephenene, dihydro mycenyl acetate, butyl-2-methyl varerate, trans-2-hexenyl acetate, dl-camphor, coumarin, pentyl cyclopentanone, iso-menthone, p-hydroxy phenyl butanone, 6-acetyl-1,1,3,4,4,6-hexamethyl tetrahydronaphthalene, ionone, p-tert-butyl cyclohexanone, o-tert-butyl cyclohexanone, 1-(2,6,6-trimethyl-1,3-cyclohexadiene-1-yl)-2-butene-1-one(Damascenone), 1-(2,6,6-trimethyl-2-cyclohexene 1-yl)-2-butene-1-one(Damascone .alpha.), 1-(2,6,6-trimethyl-1-cyclohexene-1-yl)-2-butene-1-one(Damascone .beta.), 1-(2,6,6-trimethyl-3-cyclohexene-1-yl)-2-butene-1-one (Delta Damascone), Dihydro Floriffone TD), p-mentha-8-thiol-3-one, gamma.-undecalactone, phenyl acetaldehyde dimethylacetal, octyl aldehyde, citronellal, methyl nonyl acetaldehyde, diphenyl oxide, phenyl ethyl isoamyl ether, 1,3,4,6,7,8-hexahydro-4,6,6,7,8,8-hexamethyl-cyclopenta-.gamma.-2-benzopyra n (Galaxolide), eucalyptus oil, lavender oil, lime oil, lemon oil, orange oil, grapefruit oil, pineneedle oil, peppermint oil, rosemary oil, spearmint oil, d'limonene, benzaldehyde or mixtures thereof.

26. The article of manufacture of claim 20 wherein said carrier is a food, cosmetic product, prepared food, meat, seasoning or flavoring blend.
